(19) United States
(12) Patent Application Publication
(10) Pub. No.: US 2005/0097031 A1
(43) Pub. Date: May 5, 2005

(54) Payment system using a credit card for trade and method thereof

(76) Inventor: Dong-Seok Seo, Seoul (KR)

Correspondence Address: GIFFORD, KRASS, GROH, SPRINKLE & CITKOWSKI, P.C, PO BOX 7021, TROY, MI, 48007-7021, US

(21) Appl. No.: 10/505,513

(22) PCT Filed: Feb. 25, 2003
(86) PCT No.: PCT/KR03/00376

(30) Foreign Application Priority Data
Feb. 25, 2002 (KR) 10-2002-0009863

(51) Int. Cl. G06F 17/60

(52) U.S. Cl. 705/38

(57) ABSTRACT

Disclosed is a trade settlement system and method using a credit card. When receiving a credit card number, a transaction history including a settlement day established by an importer, and an approval request from the importer, an importer transaction server checks the importer's line of credit and credit rank using the credit card number, and provides an approval history to an exporter transaction server to be notified to the exporter so that the exporter may ship and dispatch goods. When needing funds after sending the goods, the exporter applies for pre-deposit to receive the amount, and receives the amount on the settlement day according to a contract with the importer when it applies for no pre-deposit. The importer transaction server notifies the importer to deposit the amount on the settlement day, and the importer deposits the amount on the settlement day to settle it.

### CROSS REFERENCE TO RELATED APPLICATION

This application is based on Korea Patent Application No. 2002-9863 filed on Feb. 25, 2002 in the Korean Intellectual Property Office, the content of which is incorporated herein by reference.

### BACKGROUND OF THE INVENTION

(a) Field of the Invention

The present invention relates to a trading system and method thereof. More specifically, the present invention relates to a trading system and method using a credit card on a network.

(b) Description of the Related Art

As the Internet has been substantially popularized, electronic commerce has been provided to people all over the world through the same medium, the Internet. Electronic commerce includes transactions that accompany money flow using electronic media, techniques, and methods, and various operations such as buyer marketing, advertising, supplying, provision of services, production, transportation, and purchasing under B2B (business to business), B2C (business to customer), C2C (customer to customer), and B2G (business to government) information system environments which are integrated and automated.

The above-noted electronic commerce has spread to various fields such as finance, education, and exhibition, and it has also been applied to all types of transactions executed on the network and formats that support the transactions. It has mainly been used for B2C transactions in the past, but now its main target has gradually moved to B2B transactions.

According to this trend, electronic trade has appeared as international business has recently become generalized.

Electronic trade represents trade in which a user executes a portion of the trade or all its trade using an information communication network, such as a computer, that has information-processing capabilities. According to the advent of electronic trade, various electronic settlement means have appeared in order to overcome the problems of conventional settlement methods such as letters of credit (L/C) and collection, which support fluent trade settlements. Current commercial electronic settlement systems include the trade card, the BOLERO (bill of lading electronic registry organization), and the Identrus.

However, in the case of settling a trade transaction using the above-noted electronic settlement methods, it is inconvenient for an exporter and an importer to always manage an electronic settlement method and access a settlement agency system through a network, and it problematically costs time to electronically connect participants.

In addition to the trading settlement using the electronic settlement method, a case of using a conventional LIC problematically causes large incidental expenses at the time of a huge transaction, and fails to expedite the transaction.

Also, a remittance-type settlement allows fast transactions, but it provides less stability since a buyer pays the amount before he receives a corresponding product.

### SUMMARY OF THE INVENTION

It is an advantage of the present invention to provide an easy and reliable settlement on a trade transaction through a network.

In particular, it is another advantage of the present invention to provide an easy and reliable settlement on a trade transaction using a credit card.

In one aspect of the present invention, in a server for processing a settlement caused by a transaction of an importer and an exporter, an importer transaction server comprises: a card holder database for storing credit card information and credit information of the importer; a transaction database for storing a transaction history of the importer and the exporter; an approval processor for processing transaction approval on the basis of credit information of the importer when the importer requests transaction approval; and a settlement processor for notifying the importer of an amount payment, receiving a transaction amount from the importer on a settlement day which is concluded according to the transaction approval, and settling the amount provided to the exporter, the settlement day being variable by the importer, and the settlement processor processing the settlement according to the settlement day established by the importer.

In another aspect of the present invention, in a server for processing a settlement caused by a transaction of an importer and an exporter, an exporter transaction server comprises: a merchant database for storing merchant information of the exporter; a transaction database for storing a credit card approval history caused by a transaction between the importer and the exporter; a transaction processor for receiving a transaction approval history from the importer, notifying the exporter of the transaction approval history, and paying a transaction amount to the exporter; and a pre-deposit processor for checking the transaction approval history, and paying the amount caused by the transaction to the exporter when the exporter requests pre-deposit, the pre-deposit processor deducting a commission from the amount according to a commission rate variable by the importer's credit information, and paying the remainder to the exporter.

In still another aspect of the present invention, in a trade transaction system for processing a settlement caused by a transaction of an importer and an exporter, a trade settlement system using a credit card comprises: an importer transaction server including: a card holder database for storing credit card information and credit information of the importer; a transaction database for storing a transaction history between the importer and the exporter; an approval processor for processing transaction approval on the basis of credit information of the importer when the importer requests transaction approval; and a settlement processor for receiving a transaction amount from the importer on a settlement day concluded according to approval of the transaction (where the settlement data is variable by the importer), and settling the amount provided to the exporter; and an exporter transaction server including: a merchant database for storing merchant information of the exporter; a transaction database for storing a credit card approval history caused by a transaction between the importer and the exporter; a transaction processor for receiving a transaction approval history from the importer, notifying the exporter of the transaction approval history, and providing a transaction amount to the exporter according to an instruction of the importer transaction server; and a pre-deposit processor for checking the transaction approval history, deducting a commission from the amount according to a commission rate variable by the importer's credit information, and paying the remainder to the exporter when the exporter requests pre-deposit.

In still yet another aspect of the present invention, a trade settlement method of a system including an importer transaction server and an exporter transaction server connected to each other through a network, the system processing the settlement caused by a transaction of an importer and an exporter, comprises: the importer transaction server checking a line of credit and a credit rank on the basis of a credit card number, and issuing approval, when the importer provides the credit card number, a transaction history including a settlement day established by the importer, and an approval request; the importer transaction server providing an approval history to the exporter transaction server to be notified to the exporter; the exporter transaction server providing a transaction amount to the exporter; the importer transaction server notifying the importer to deposit the amount on the settlement day; and the importer transaction server settling the amount provided by the exporter transaction server to the exporter by using the amount deposited on the settlement day.

The method further comprises: the exporter transaction server providing a purchase request history to the importer transaction server when the exporter requests a purchase; the importer transaction server comparing the purchase request history of the exporter with a payment request history provided by the importer when a payment request is provided from the importer that has received goods; processing the purchase when the purchase request history and the payment request history are matched; and notifying the exporter and the importer of a purchase processing result through the exporter transaction server.

The method further comprises: the exporter transaction server requesting an approval history or a purchase history check from the importer transaction server when the exporter requests pre-deposit before an amount payment day; the importer transaction server providing the exporter transaction server with the approval history or a purchase history checking result together with information on a merchant commission rate calculated according to the credit rank of the importer; and the exporter transaction server deducting a commission from the amount and providing the remainder to the exporter.

The method further comprises: the importer transaction server providing an approval cancellation request to the exporter transaction server to be notified to the exporter, when the importer generates the approval cancellation request; the exporter providing the importer transaction server with an approval cancellation checking history provided by the exporter that has received the returned goods from the importer; and the importer transaction server comparing the approval cancellation history provided by the importer with the approval cancellation checking history provided by the exporter, and canceling the transaction approval using a credit card between the importer and the exporter when the histories are matched.

The method further comprises: the exporter transaction server providing an objection history to the importer transaction server when the exporter is notified of the approval cancellation request and requests the objection; the importer transaction server notifying the importer of the objection history; the importer transaction server notifying a judgment system of an objection-raised transaction history; the importer transaction server respectively notifying the importer and the exporter of a judgment result when the judgment system notifies of the judgment result on the objection; and the importer transaction server canceling the approval or paying the amount according to the judgment result.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a trade transaction system using a credit card according to a preferred embodiment of the present invention;

FIG. 2 shows an exemplified diagram of connection and transaction states between respective components of a trade transaction system according to a first preferred embodiment of the present invention;

FIGS. 3(a) and 3(b) show a flowchart for a trade transaction method using a credit card according to a first preferred embodiment of the present invention;

FIG. 4 shows an exemplified diagram of a connection state and information transmission between respective components of a trade transaction system according to a second preferred embodiment of the present invention;

FIG. 5 shows a purchase process according to a second preferred embodiment of the present invention;

FIG. 6 shows an approval canceling process according to a second preferred embodiment of the present invention;

FIG. 7 shows an exemplified diagram of a connection state and information transmission between respective components when an objection is made according to a second preferred embodiment of the present invention;

FIG. 8 shows a flowchart for processing the objection according to a second preferred embodiment of the present invention;

FIG. 9 shows a configuration of each server according to another preferred embodiment of the present invention;

FIG. 10 shows an exemplified diagram of a switching module of FIG. 9;

FIG. 11 shows an exemplified diagram of an operation of the switching module when a domestic buyer deals with an overseas seller;

FIG. 12 shows an exemplified diagram of an operation of the switching module when a domestic buyer deals with a domestic seller; and

FIG. 13 shows an exemplified diagram of an operation of the switching module when a domestic seller deals with an overseas buyer.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

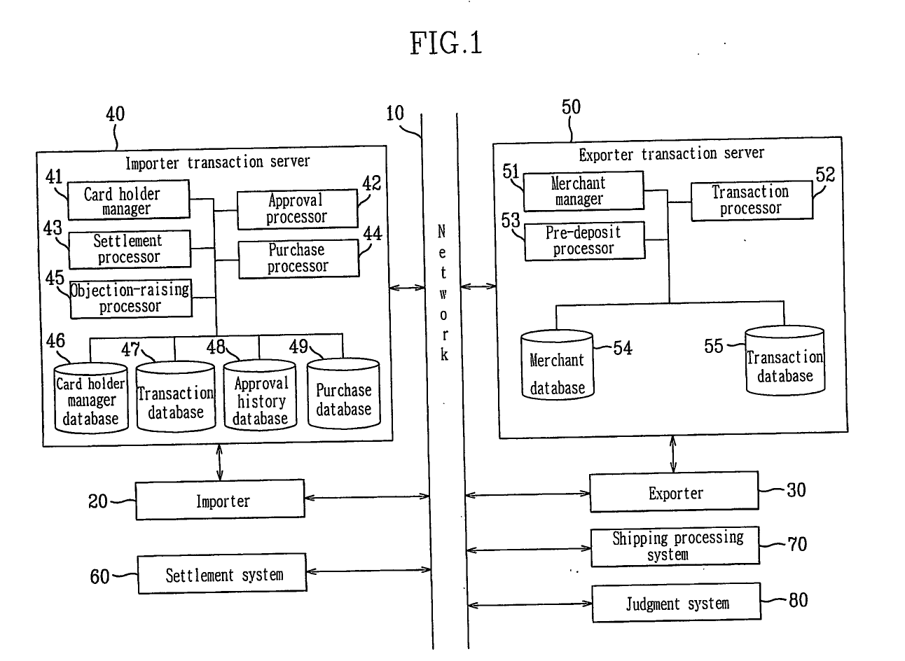

FIG. 1 shows a whole configuration of a trade and financial transaction system according to a preferred embodiment of the present invention.

As shown, the trade and financial transaction system comprises an importer 20, an exporter 30, an importer transaction server 40, and an exporter transaction server 50 connected with one another through a network 10.

In this instance, the importer 20 and the exporter 30 represent clients that are main transaction bodies (buyers and sellers) for executing international trades and financial transactions, including a server managed by a company as well as communication devices including a computer, a mobile terminal, a PDA, and an Internet-TV that use a web browser such as Internet Explorer by Microsoft or Navigator by Netscape.

The importer transaction server 40 for processing a settlement caused by a trade transaction is a server of a bank or a card issuer for processing a settlement using a credit card. The importer transaction server 40 comprises a card holder manager 41, an approval processor 42, a settlement processor 43, a purchase processor 44, an objection-raising processor 45, a card holder database 46, and a transaction database 47.

The card holder manager 41 allows a user to be a card holder when they can settle a trade transaction using a credit card, and manages the user as a card holder. Card holder information for this membership is stored in the card holder database 46. The card holder database 46 stores information on the importers registered as card holders, the information including a credit card number, a password, an importer's name, an entrepreneur's address, an entrepreneur's number, and a telephone number for each importer. In addition, the card holder database 46 stores credit information including an arrears status, an arrears rate, a credit rank, and a line of credit for each depending on the transaction history for each importer, and it also stores commission rate information that is applicable to an exporter.

In the preferred embodiment, the commission for each merchant is differently established depending on the importer's credit in consideration of the amount of transaction cost during a trade transaction. That is, since settlement using a credit card cannot be activated because of a heavy commission burden of an exporter in the case of a settlement using a credit card with a commission rate of a general credit card merchant, the credit rank is divided into a plurality of ranks on the basis of an importer's credit information provided by a credit authority, and a different merchant commission is set according to each rank. Therefore, the exporter can employ a credit rank of an importer with a good credit rank to perform a credit card settlement with a lower merchant commission.

The approval processor 42 approves a settlement transaction using a credit card, or cancels the corresponding approval on the basis of credit information for each importer.

The settlement processor 43 proceeds to settle the transaction executed through a credit card, and in particular, it settles the transaction on the settlement day specified not by the importer transaction server but by the importer. The commission generated according to the freely designated settlement day is billed to a determined commission payer when the importer and the exporter conclude the transaction.

The transaction database 47 stores a transaction history using a credit card for each importer, for example, a transaction day, a transaction item, a transaction cost, a designated settlement day, and a commission payer for each importer.

An approval history database 48 stores an approval history on transaction approval, and an approval cancellation history, and a purchase database 49 stores a purchase processing history according to a purchase request by an exporter.

In addition, the importer transaction server 40 may further comprise a purchase processor 44 for processing a purchase, and an objection raising processor 45 for processing the objection on approval cancellation.

The exporter transaction server 50 transmits and receives information to/from the importer transaction server 40 through the network 10 to process the corresponding settlement caused by a trade transaction of the importer 20 and the exporter 30. The exporter transaction server 50 is a server of a bank or a card issuer for processing the settlement using a credit card, and it comprises a merchant manager 51, a transaction processor 52, a pre-deposit processor 53, a merchant database 54, and a transaction database 55.

The merchant manager 51 allows registration for a merchant that can settle a trade transaction using a credit card, and manages the merchant. Merchant information for this registration is stored in the merchant database 54. The merchant database 54 stores information on the importers registered as merchants for executing transaction using a credit card, the information including a merchant number, an exporter's name, a company address, an entrepreneur's number, and a telephone number for each exporter.

The transaction processor 52 performs an interface function of providing information provided by the importer transaction server 40 to the exporter 30, or of providing information on various requests including an approval check, a purchase request, and objection raising requested by the exporter 30 to the importer transaction server 40, and the transaction processor 52 provides an amount to the exporter 30 according to an amount payment request from the importer transaction server 40.

The pre-deposit processor 53 prepays a corresponding amount to the exporter 30 according to an approval history provided by the importer transaction server 40, when the exporter 30 requests a pre-deposit before an amount payment day.

The transaction database 55 stores a transaction history using a credit card for each exporter, for example transaction history including information on transaction days, transaction items, transaction amounts, designated settlement days, and commission payers for each exporter.

In the preferred embodiment, the respective components of the importer and exporter transaction servers 40 and 50 are classified as described above, but they are not restricted to the above-noted classification.

A trade settlement system using a credit card according to the preferred embodiment of the present invention (referred to as the trade settlement system hereinafter) is connected to a settlement system 60 through a network to settle transaction amounts and commissions between the importer transaction server 40 and the exporter transaction server 50, and it is also connected to a shipping processing system 70 to ship goods of the exporter or return goods of the importer. Further, the trade settlement system is connected to a judgment system 80 to claim judgment caused by objection-raising.

Next, a trade settlement method using a credit card according to a preferred embodiment of the present invention will be described based on the above-noted configuration.

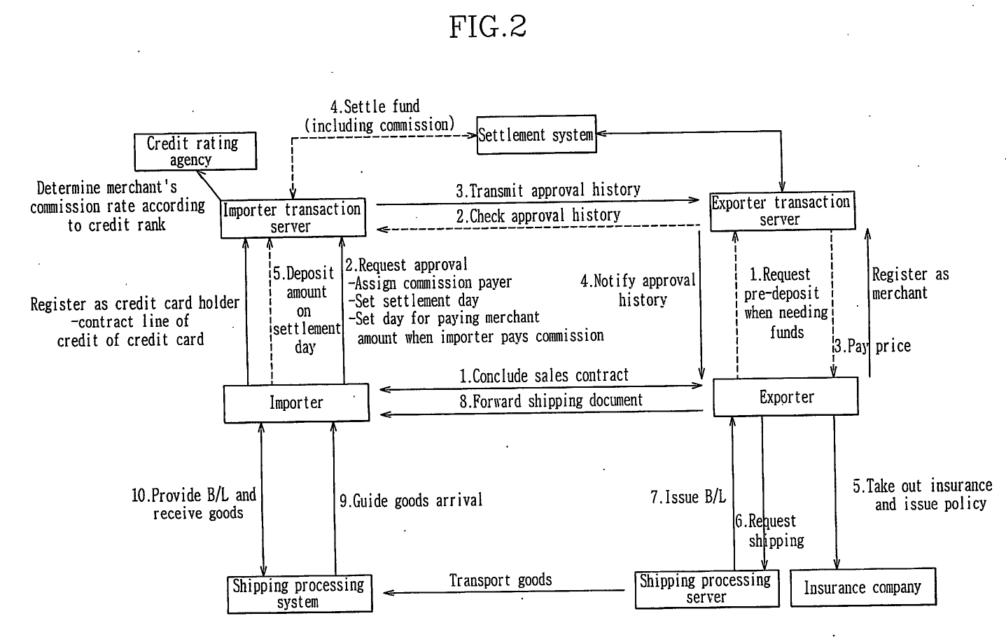

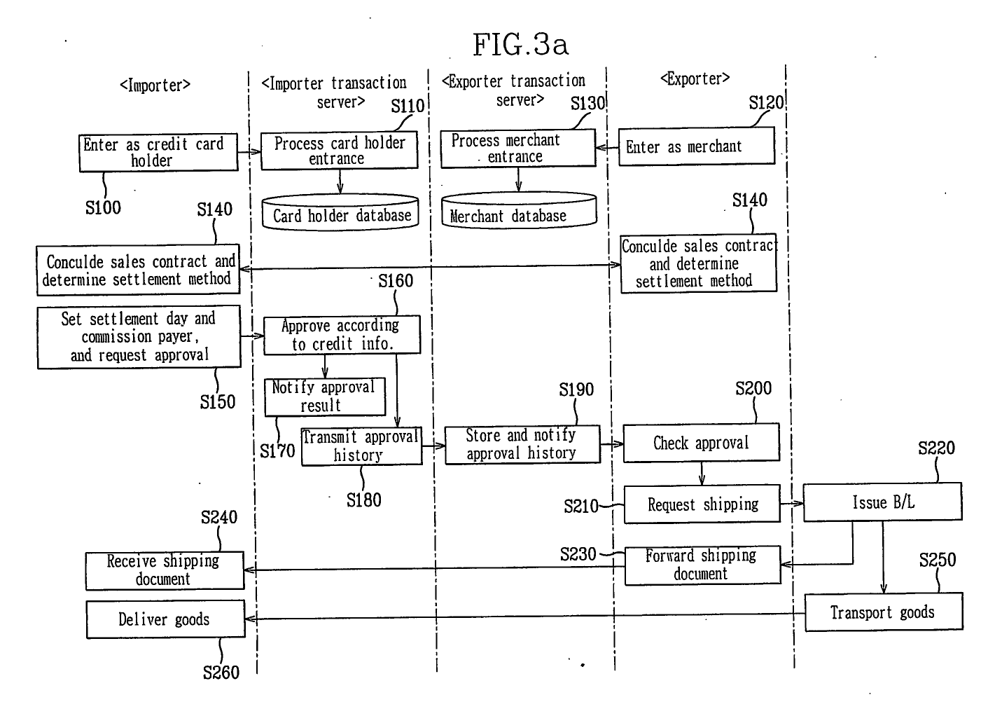

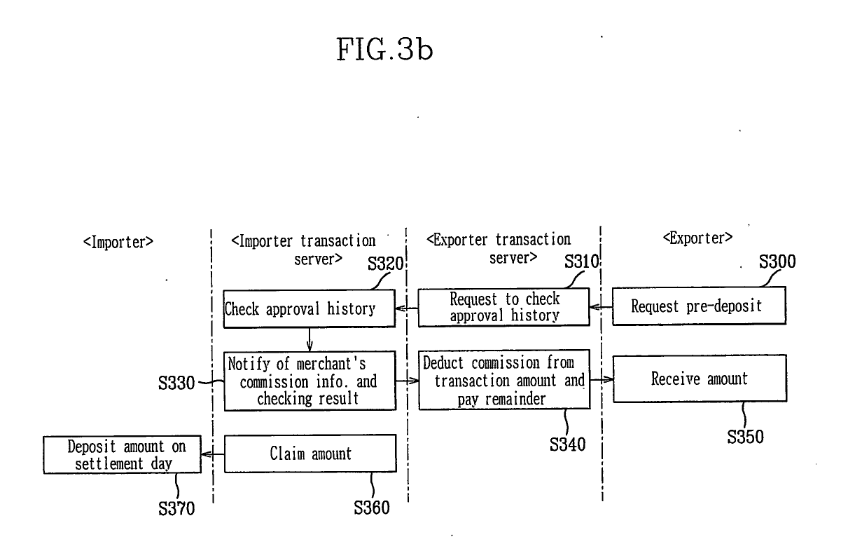

FIG. 2 shows an exemplified diagram of a connection status between respective components of a trade settlement system and a corresponding information transmission according to a first preferred embodiment of the present invention, and FIGS. 3(a) and 3(b) sequentially show a settlement method thereof.

As shown in FIG. 3(a), an importer 20 for attempting to perform a trade transaction on the credit card basis requests a credit card membership registration from an importer transaction server 40 in step S100.

The importer 20 is connected to the importer transaction server 40 through a network such as a telephone to request the credit card membership registration, or writes registration items in a written statement and requests the same by mail, fax, or delivery.

For example, when attempting to request the membership registration through the Internet, the importer 20 drives a network access program (e.g., a web browser), and inputs a URL to access the importer transaction server 40. Next, the importer transaction server 40 provides a page for membership registration to the importer 20, and the importer 20 writes corresponding items on the transmitted registration page and provides the same to the importer transaction server 40. Accordingly, the importer transaction server 40 gives a credit card number to the importer 20, and stores importer information in the card holder database 46 to finish membership registration in step S110.

The exporter 30 accesses the exporter transaction server 50 to request a registration as a merchant that provides a credit-card-based settlement process, and a request for registration as a merchant by the exporter can be performed on the Internet or in a written statement in the like manner of the credit card membership registration by the importer. The exporter transaction server 50 provides a merchant number to the exporter 30 that accesses the exporter transaction server 50 in various ways, stores corresponding information to the merchant database 54, and manages it, in steps S120 and S130.

As described above, the importer 20 and the exporter 30 agree on a sales contract and determine a corresponding settlement method under the state that they are respectively registered as a card holder and a merchant for settling trade transactions using a credit card in step S140.

When a settlement method using a credit card is selected, the exporter 30 provides the importer 20 with information on the exporter transaction server 50 dealt with by the exporter 30, for example a merchant number of the exporter (the merchant number includes a bank account number of a general bank), a URL of the exporter transaction server 50, and a telephone number.

The importer 20 establishes a settlement day for paying a transaction amount according to the sales contract with the exporter, accesses the importer transaction server 40, and provides it with a transaction history including a transaction amount, and a credit card number, a password, and a designated settlement day to request approval in step S150. In this instance, the importer provides information on the exporter transaction server dealt with by the exporter to it so as to subsequently pay the amount to the exporter according to approval results. The importer and the exporter can confer with each other on the commission payer, and when the commission payer is the importer, the importer may determine a transaction amount settlement day when the amount is provided to the exporter.

The approval processor 42 of the importer transaction server 40 searches the card holder database 46 on the basis of the provided credit card number to check a line of credit of the corresponding importer, when receiving an approval request from the importer 20. The approval processor 42 approves an amount settlement of the settlement day requested by the importer when the approval-requested transaction amount is within the line of credit in step S160.

The import transaction server 40 notifies the importer 20 of an approval result in step S170, assigns a transaction number to the approval result to store it in the approval history database 48, and transmits an approval history to the exporter transaction server 50 dealt with by the corresponding exporter through the network 10 in step S180. The approval history includes transaction amounts of the importer and the exporter, an approval number, and a merchant number of the exporter. The transaction processor 52 of the exporter transaction server 50 stores the approval history caused by the transaction approval by the exporter and the importer in the transaction database 47 and provides it to the exporter 30 to notify the exporter 30 of the settlement approval in step S190, when receiving the approval history from the importer transaction server 40.

Hence, the exporter requests shipping of the transaction goods from the shipping processing system 70 of a shipping company, and the shipping processing system 70 issues a B/L (bill of lading) according to shipping, and provides the B/L to the exporter 30 in steps S200 through S220. Also, the exporter 30 requests insurance for shipping from an insurance company to receive an insurance policy.

The exporter 30 provides shipping documents including the B/L to the importer 20 through the network 10 or by mail in a written statement to thereby deliver goods in steps S240 through S260, when receiving the B/L from the shipping processing system 70.

After the transaction settlement, the settlement approval using a credit card, and the delivery of goods are finished, the exporter 30 can access the exporter transaction server 50 to request a pre-deposit when the exporter 30 needs a pre-deposit before the transaction amount payment day.

As shown in FIG. 3(b), when the exporter 30 requests the pre-deposit, the pre-deposit processor 53 of the exporter transaction server 50 searches the transaction database 47 on the basis of the merchant number and the approval number of the exporter 30 to request an approval history check from the corresponding importer transaction server 40 in steps S300 and S310.

The approval processor 42 of the importer transaction server 40 searches the approval history database 48 on the basis of the merchant number and the approval number, finds the approval history, and provides the exporter transaction server 50 with the approval history and information on a merchant commission that is applicable to the corresponding transaction in steps S320 and S330.

The exporter transaction server 50 pays the amount of the corresponding transaction to the exporter 30. In this instance, as the exporter requests a pre-deposit before the settlement day notified by the importer transaction server 40, the exporter transaction server 50 calculates a merchant commission according to a period from the time for the exporter transaction server to prepay the amount to the settlement day (the day when the importer will settle the amount), deducts the merchant commission from the amount, and provides the remainder to the exporter in steps S340 and S350.

After this, the exporter transaction server 50 settles the amount with the exporter transaction server 40 through a settlement system. That is, the exporter transaction server 40 calculates the amount prepaid to the exporter and a treatment commission.

When the exporter requests no pre-deposit, the settlement processor 43 of the import transaction server 40 notifies the importer 20 to deposit the amount on the settlement day in step S360, instructs the exporter transaction server 50 to pay the transaction amount to the exporter on the merchant amount payment day, and when the importer 20 deposits the amount on the settlement day, the settlement processor 43 settles the corresponding amount in step S370.

As described, the importer can freely determine the settlement day according to a fund raising status and execute a trade transaction using a credit card. Also, the exporter can receive the amount in advance depending on a fund raising status, and in this instance, the exporter receives the amount from which the commission caused by the pre-deposit is deducted according to the credit rating of the importer.

In the above-described embodiment, a previous remittance method for receiving approval in advance using a credit card and shipping goods is described, and further, the goods may be shipped in advance, and a subsequent approval process may be performed using a credit card. In this case of a post-remittance method, a sales contract is made between an exporter and an importer, the exporter ships goods in advance, the importer receives the goods, and the importer then accesses the importer transaction server 40 to request approval. In this case, the difference from the previous description is that the approval time is after the delivery of the goods, and accordingly, no detailed description will be provided.

Also, a method for settling the amount using a credit card has been described in the above-noted preferred embodiment, but without being restricted to this, the importer may settle the amount with cash.

In the above-mentioned preferred embodiment, the importer transaction server approves the settlement using a credit card, and it may further perform a purchase process.

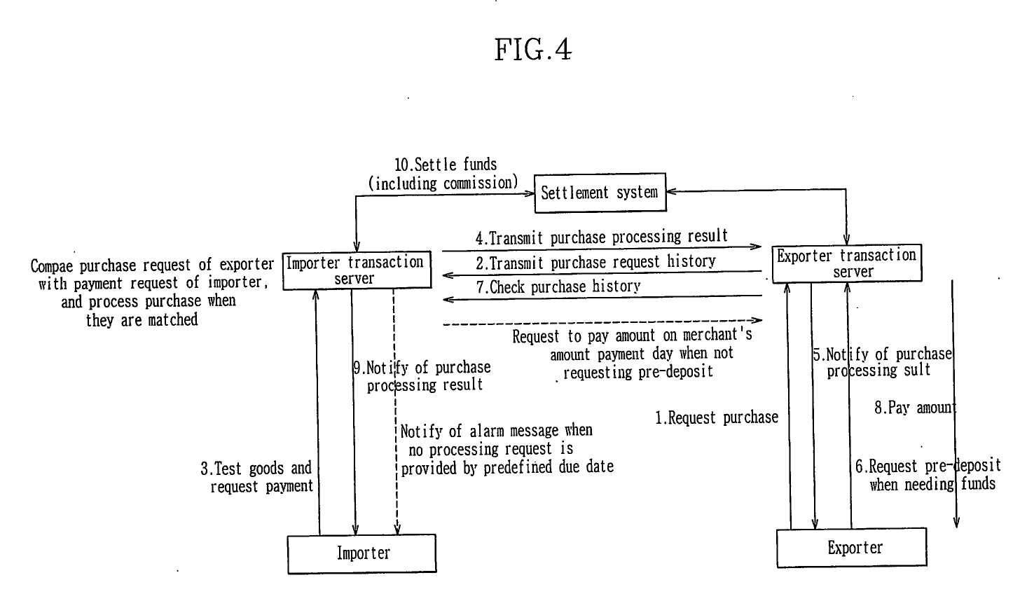

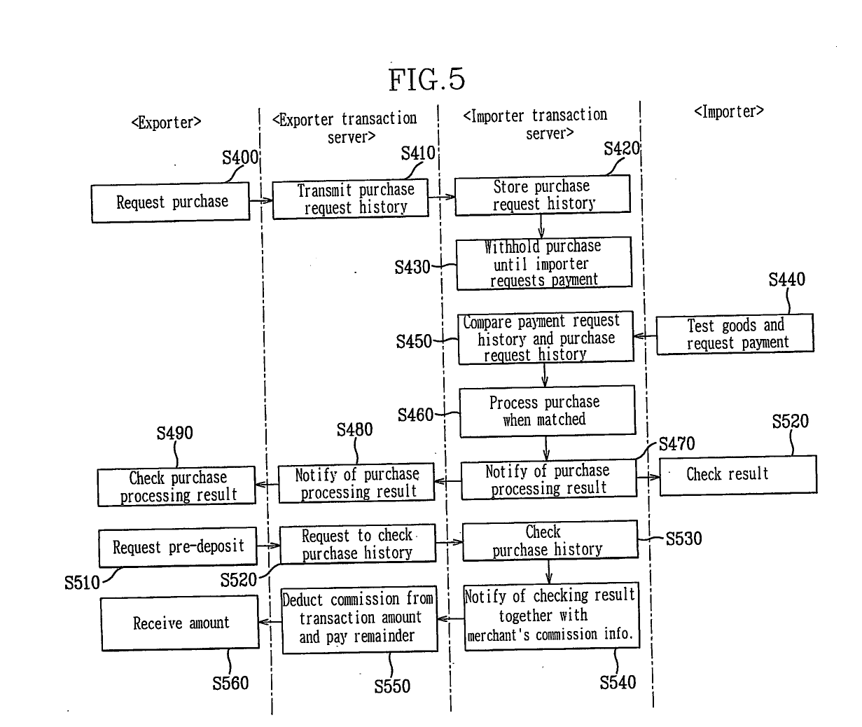

FIG. 4 shows an exemplified connection status between the respective components of the trade settlement system for performing an approval and purchase process using a credit card, and an information transmission case according to a second preferred embodiment of the present invention, and FIG. 5 sequentially shows a purchase process.

In the second preferred embodiment, in the like manner of the first preferred embodiment, an importer and an exporter respectively registered as a card holder and a merchant for performing transactions using a credit card respectively make a contract with the importer transaction server 40 and the exporter transaction server 50, select a settlement method using a credit card, and when the importer requests approval, the importer transaction server 40 issues approval, and provides its history to the exporter transaction server 50. Accordingly, the exporter requests shipping and provides corresponding shipping documents to the importer 20 to thereby deliver goods.

Since the approval process is matched with that of the first preferred embodiment, no corresponding description will be provided.

Next, the exporter 30 requests a purchase from the exporter transaction server 50. As shown in FIG. 5, so as to execute the purchase request, the exporter 30 provides information on the importer transaction server dealt with by the importer that has made the contract together with a transacted amount, an approval number, a volume of shipped goods, a goods category, a shipping day, and a delivery date, and the exporter transaction server 50 transmits a purchase request history to the importer transaction server 40 in steps S400 and S410.

On receiving the purchase request history, the purchase processor 44 of the importer transaction server 40 withholds the purchase request process until a payment request is provided from the importer, and stores the purchase request history in the purchase database 49 in steps S420 and S430.

The importer 20 receives the goods shipped by the exporter through the shipping processing system, checks them, and requests a payment from the importer transaction server 40 in step S440. The importer 20 provides a payment request history including a volume and a category of the delivered goods, a transaction amount to be paid, an approval number, and a delivery date.

The purchase processor 44 of the importer transaction server 40 compares the exporter's purchase request history stored in the purchase database 49 with the payment request history provided by the importer, and when they are matched, the purchase processor 44 processes the purchase in steps S450 and S460, provides a purchase processing result to the exporter transaction server 50 to be notified to the exporter in steps S470 through S490, and notifies the importer 20 of the purchase processing result in step S500.

After this, when the exporter needs funds and requests a pre-deposit before a settlement day in step S510, the pre-deposit processor 53 of the exporter transaction server 50 requests a purchase history check from the importer transaction server 40. Accordingly, when the settlement processor 43 of the importer transaction server 40 checks the purchase history and notifies of a checking result together with information on the applicable merchant commission, the exporter transaction server 50 deducts the merchant commission notified from the importer transaction server 40, and provides the transaction amount to the exporter 30 in steps S520 through S560.

When the exporter does not request a pre-deposit, the importer transaction server 40 notifies the exporter transaction server 50 to pay the amount to the exporter on the merchant amount payment day, and when the importer 20 deposits the amount on the settlement day, the importer transaction server 40 settles the corresponding amount.

When the importer receives the goods and finds a flaw or finds that the quantity of the delivered goods is mismatched, the importer discusses the item with the exporter 30 with respect to a modified purchase amount.

Accordingly, the exporter 30 requests modification of the purchase through the modified purchase amount, and the exporter transaction server 50 provides a modified purchase request history including the modified purchase amount to the importer transaction server 40.

On receiving the payment request history from the importer 20, the purchase processor 44 of the importer transaction server 40 compares the provided payment request history with the modified purchase request history, and when they are matched, the purchase processor 44 processes the purchase. Subsequent processes are matched with those described in the previous steps S470 through S560.

When the importer 20 receives the goods and finds many flaws in them, the importer 20 can return them and cancel the transaction approval so as to cancel the transaction.

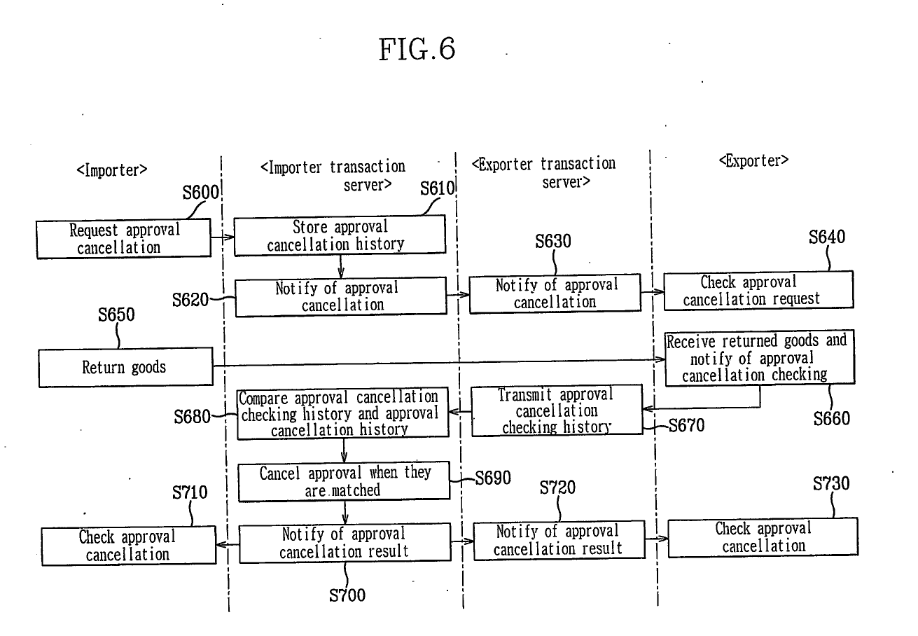

FIG. 6 shows an approval cancellation process.

As shown, when the importer provides an approval cancellation history including a category and a quantity of the goods to be returned, and an approval number, and requests approval cancellation in step S600, the approval processor 42 of the importer transaction server 40 sets a due date for requesting a reply to the approval cancellation and notifies the exporter transaction server 50 of the approval cancellation to be notified to the exporter 30 in steps S610 through S640.

The importer returns the troubled goods through the shipping processing system 70, and provides a B/L on the returned goods to the exporter 30. When the goods are returned through the shipping processing system 70, the exporter notifies of an approval cancellation check, and in this instance, it also provides an approval cancellation checking history including a quantity and a category of the returned goods, and an approval number in steps S650 and S660.

The exporter transaction server 50 provides the approval cancellation checking history to the importer transaction server 40 in step S670, and the approval processor 42 of the importer transaction server 40 compares the approval cancellation history provided by the importer with the approval cancellation checking history provided by the exporter, and when they are matched, the approval processor 42 cancels the transaction approval using a credit card between the importer and the exporter in steps S680 and S690.

The approval processor 42 of the importer transaction server 40 stores an approval cancellation result to the approval history database 48, and notifies the importer 20 and the exporter transaction server 50 of the approval cancellation result in steps S700 through S730.

Here, the exporter may make an objection to the importer's approval cancellation.

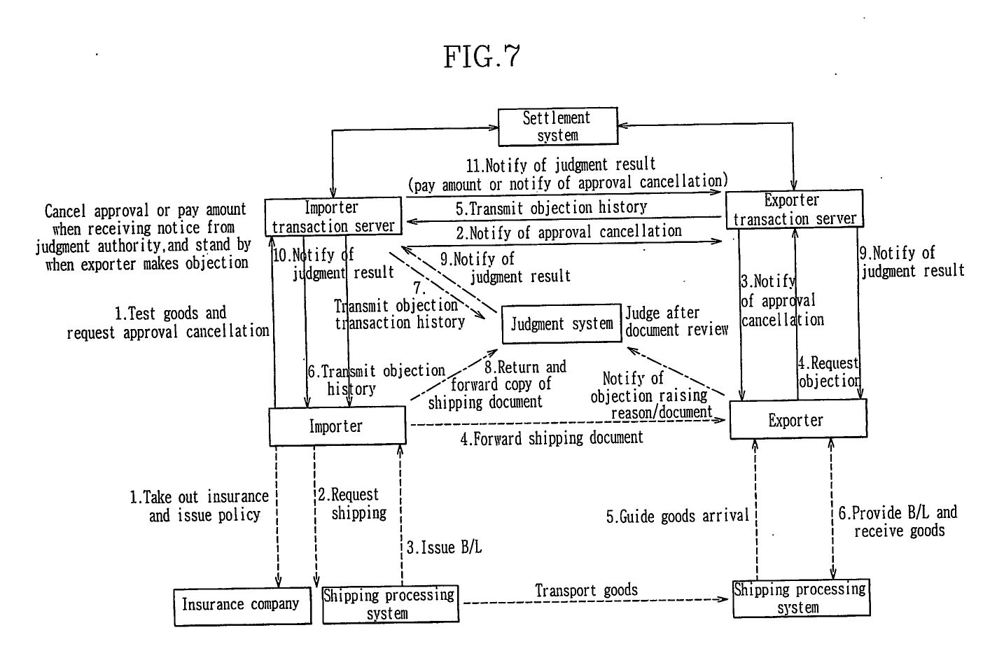

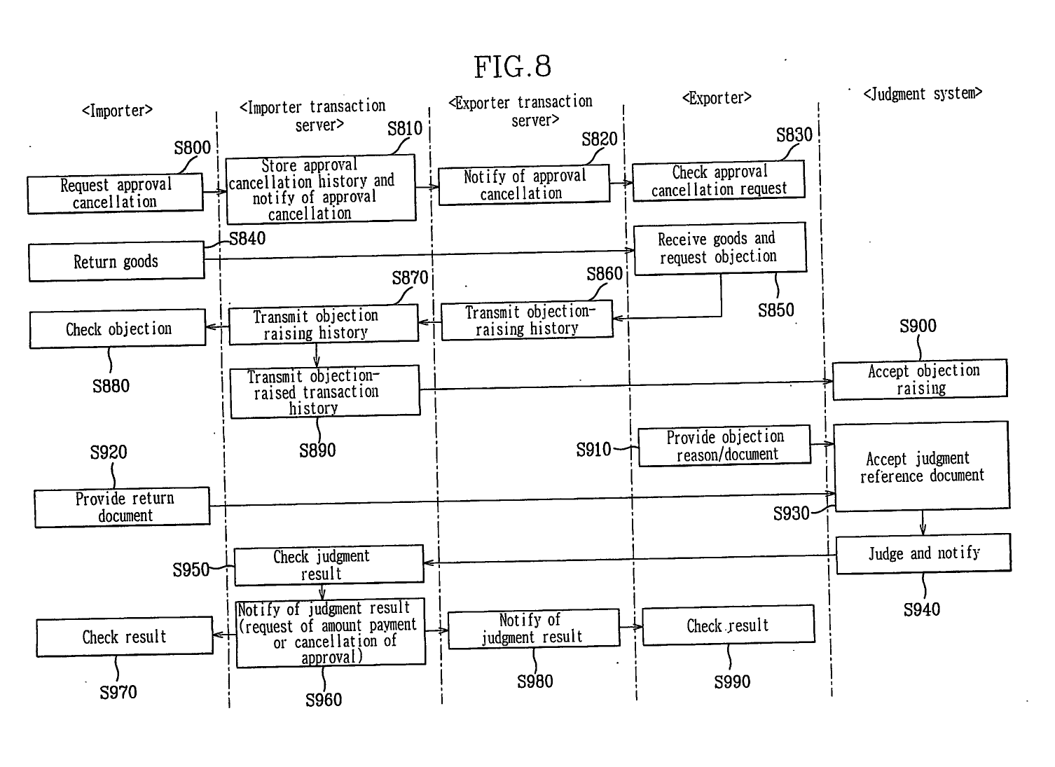

FIG. 7 shows an exemplified diagram of a connection state and information transmission between respective components when an objection is made, and FIG. 8 shows a flowchart for processing the objection.

As shown in FIGS. 7 and 8, in the like manner of the above-noted approval cancellation process, the importer 20 requests approval cancellation, notifies the exporter 30 thereof, returns the goods, and when goods other than the initially shipped goods are returned, the exporter 30 may make an objection in steps S800 through S850.

The exporter transaction server 50 notifies the importer transaction server 40 of an objection making request provided by the exporter 30, and provides the importer transaction server 40 with an objection history including features and the quantity of the transacted goods, the category and the quantity of the returned goods, and a reason for the objection in step S860.

The exporter transaction server 50 provides the objection history to the importer transaction server 40, and the objection raising processor 45 of the importer transaction server 40 provides the objection history to the importer 20 in steps S870 through S890, and provides the objection history to the judgment system 80 in steps S890 and S900.

When the exporter has raised an objection, the importer transaction server 40 does not cancel the approval or pay the amount until a judgment result on the objection from the judgment system is notified.

The exporter raises an objection to the exporter transaction server to be notified to the importer, provides the objection history to the judgment system 80 to claim a judgment in step S910, and the importer provides a copy of the shipping document on the returned goods to the judgment system 80 when receiving the objection history in step S920.

After this, the judgment system 80 judges the copy of the returned goods shipping document of the importer and the objection history of the exporter to provide a result to the importer transaction server 40 in steps S930 and S940. The importer transaction server 40 notifies the importer 20 of the judgment result, and notifies the exporter 30 thereof through the exporter transaction server 50 in steps S950 through S990. After this, the importer transaction server 40 cancels the approval or pays the amount of the transaction between the importer and the exporter according to the judgment result.

In the above preferred embodiment, an additional judgment system has judged the objection raised by the exporter, and in addition, the importer transaction server or the settlement system can perform the judgment process, and a person skilled in the art can easily infer the configuration and functions of the importer transaction server for performing the judgment process through the above-described embodiment.

According to the above-noted embodiment, the importer transaction server for settling the trade transaction using a credit card can perform a purchase process as well as an approval through a credit card settlement, and process modification of a purchase amount, cancellation of approval, and a request of an objection.

When receiving no response from the other party that has received the requests such as the above-noted purchase, the approval cancellation, or the objection raising by the due date, the importer transaction server or the exporter transaction server can issue a warning for a response request to the importer or the exporter.

The settlement on the credit card basis caused by a trade transaction between the importer and the exporter according to the first and the second preferred embodiments can be processed by an interface between the importer transaction server and the exporter transaction server or through an additional agency device. When the additional agency device processes the credit card settlement executed between the importer and the exporter, the agency device is respectively connected to the importer transaction server and the exporter transaction server to transmit and receive data compares the purchase request from the exporter (the purchase request being performed by the importer transaction server) with the payment request history from the importer, notifies of various transaction histories, and performs a warning function. Components of the agency device for processing the jobs and functions of the respective components can be easily inferred from the functions of the importer transaction server according to the first and second preferred embodiments.

In the above-described preferred embodiments, digital signatures can be used at the time of data transmission between the importer transaction server and the exporter transaction server, between the importer and the exporter, between the importer and the importer transaction server, and between the exporter and the exporter transaction server, thereby enhancing stability.

In the above-noted embodiments, the configuration of the importer transaction server (referred to as a server hereinafter) or the exporter transaction server may be differently configured.

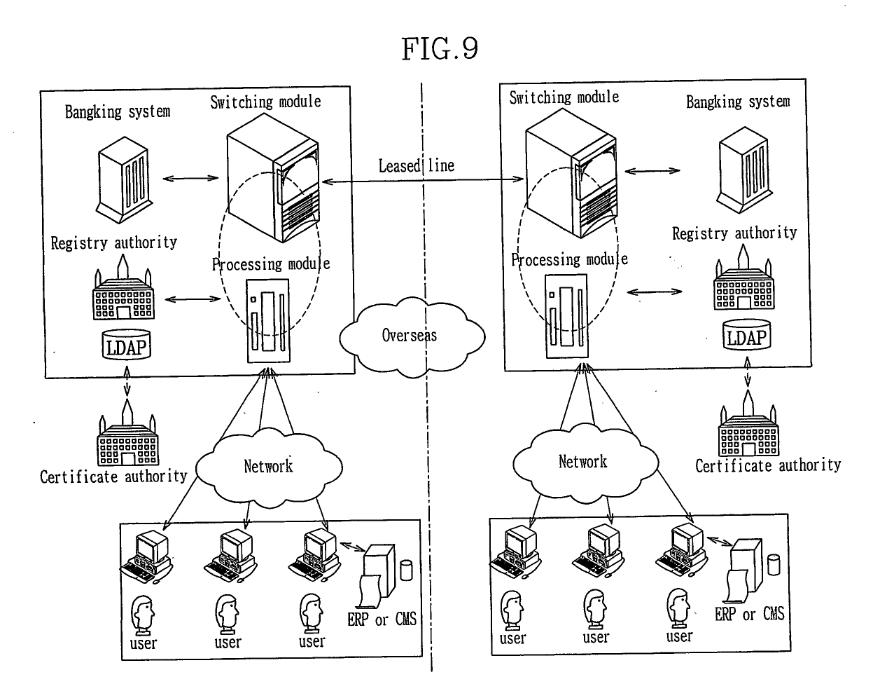

FIG. 9 shows a configuration of the server according to another preferred embodiment of the present invention.

As shown, the server includes a switching module for performing an interface function and a processing module for executing an approval or settlement process, and it may further include a control module (not illustrated) for managing modifications of respective modules. The processing module of the importer transaction server includes an above-noted card holder manager, an approval processor, a settlement processor, a purchase processor, and an objection raising processor, and the processing module of the exporter transaction server includes a merchant manager, a transaction processor, and a pre-deposit processor.

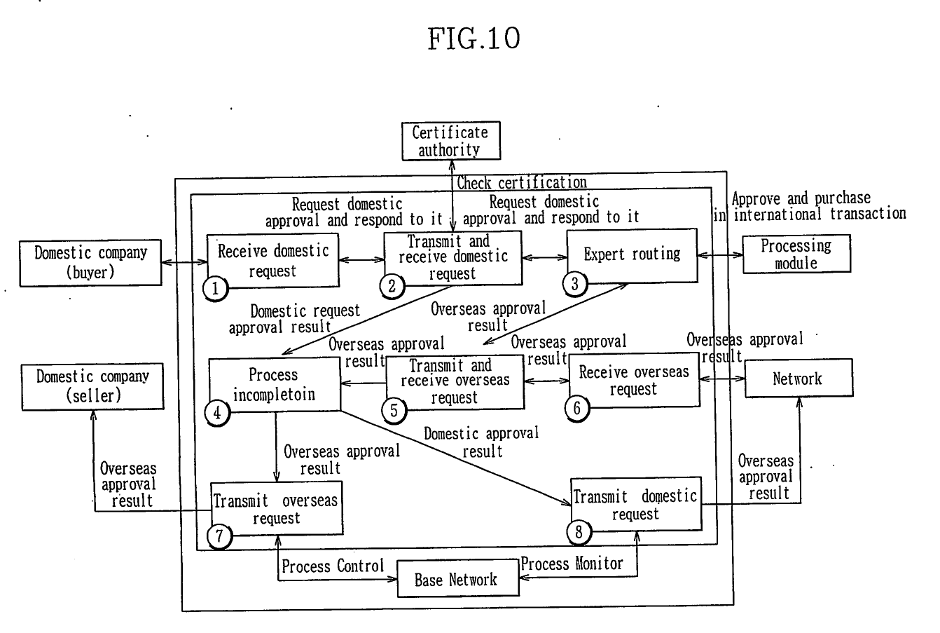

FIG. 10 shows a brief block diagram of the switching module.

As shown, the switching module performs an interface function between one of a domestic company (or a buyer) that is an importer and a domestic company (or a seller) that is an exporter, and the processing module, and also performs an interface function with another server (an importer transaction server or an exporter transaction server) through a network. Hence, the switching module may be selectively added to each server to be used.

The function of the switching module will now be described in detail.

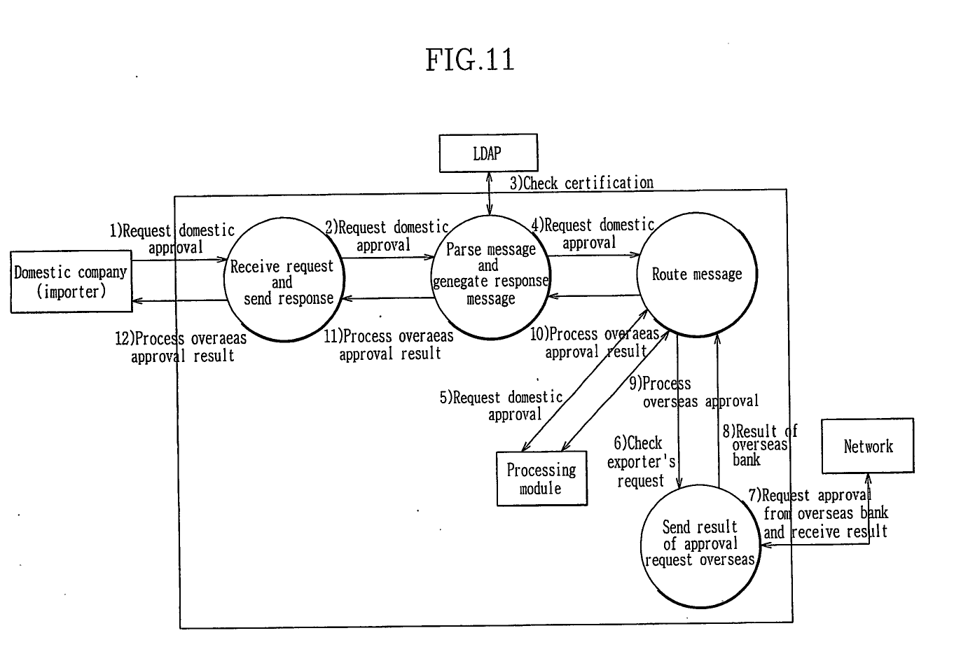

FIGS. 11 through 13 show exemplified operation processes of the switching module.

FIG. 11 shows an exemplified operation of the switching module when a domestic importer (a buyer) deals with an overseas exporter (a seller.) As described in the above-noted preferred embodiment, when the importer accesses an importer transaction server and requests approval so as to perform a transaction using a credit card, the switching module of the importer transaction server receives the request, parses a message, and provides the parsed message to the processing module, thereby processing it in the like manner of the above-noted embodiments.

When receiving a processing result from the server of the overseas exporter through the network, the switching module processes the overseas approval result, and provides it to the importer.

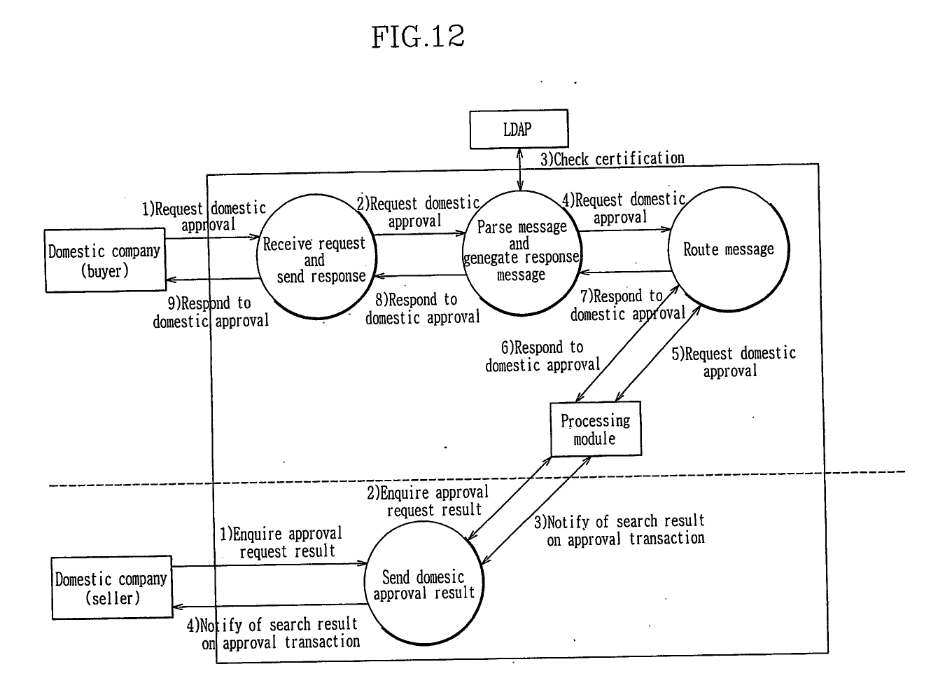

FIG. 12 shows an exemplified operation of the switching module when a domestic importer that is a buyer deals with a domestic seller.

When a domestic seller accesses a server of a bank where the seller has an account, and requests approval so as to perform a transaction using a credit card, the switching module of the server receives the request, parses a message, and provides it to the processing module to be processed as described above. Accordingly, the processing module transmits a processing result to the switching module of the server dealt with by the seller to be thereby provided to the seller. Also, when the seller enquires of an approval request result, the switching module of the bank server dealt with by the seller enquires of a request result of the processing module of the server dealt with by the buyer, and provides a corresponding result to the seller.

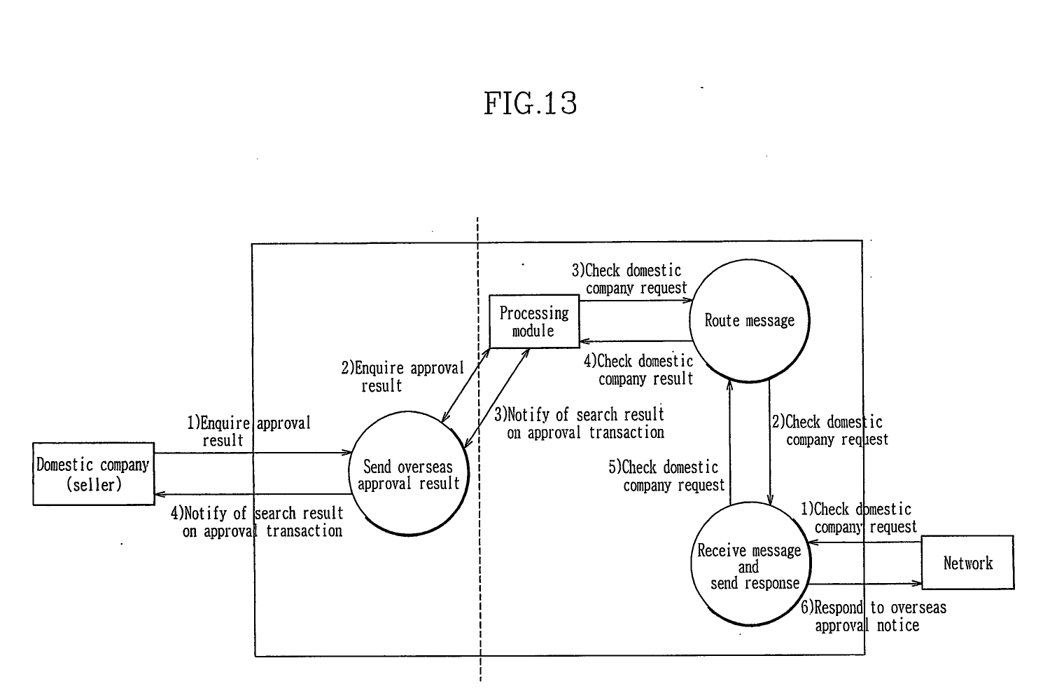

Further, FIG. 13 shows an exemplified operation of the switching module when a domestic exporter that is a seller deals with an overseas importer that is a buyer.

When the domestic seller accesses the exporter transaction server and enquires of an approval result of the buyer dealt with by the seller, the switching module of the exporter transaction module enquires of the approval result of the processing module of the importer transaction server of the buyer. Accordingly, the processing module of the importer transaction server provides a search result on the approval transaction to the switching module of the exporter transaction server to be provided to the seller. When the buyer requests seller information, the switching module of the exporter transaction server receives the corresponding information from the processing module and provides it to the buyer.

As described, the switching module performs the interface function between the processing module and the client (the seller or the buyer) and the interface function with the processing module of the other server, thereby fluently performing information communication between the respective servers and information communication between the seller and the buyer.

Therefore, the settlement caused by a trade conclusion between the importer and the exporter using a credit card according to the preferred embodiments of the present invention is easily executed.

In particular, by supporting use of various settlement methods depending on an amount settlement contract between the exporter and the importer, effective electronic settlement for B2B electronic commerce is enabled.

By quickly and effectively processing the settlement of the transaction amount in the trade buying and selling according to the settlement processing using a credit card, additional costs and risks for settlement of the traders are minimized, and accordingly, the transactions are further promoted.

Also, by partially modifying or additionally developing the credit card settlement-processing infrastructure, it can be conveniently carried out.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. In a server for processing a settlement caused by a transaction of an importer and an exporter, an importer transaction server comprising:
a card holder database for storing credit card information and credit information of the importer;
a transaction database for storing a transaction history of the importer and the exporter;
an approval processor for processing transaction approval on the basis of credit information of the importer when the importer requests transaction approval; and
a settlement processor for notifying the importer of an amount payment, receiving a transaction amount from the importer on a settlement day which is concluded according to the transaction approval, and settling the amount provided to the exporter, the settlement day being variable by the importer, and the settlement processor processing the settlement according to the settlement day established by the importer.

2. In a server for processing a settlement caused by a transaction of an importer and an exporter, an exporter transaction server comprising:
a merchant database for storing merchant information of the exporter;
a transaction database for storing a credit card approval history caused by a transaction between the importer and the exporter;
a transaction processor for receiving a transaction approval history from the importer, notifying the exporter of the transaction approval history, and paying a transaction amount to the exporter; and
a pre-deposit processor for checking the transaction approval history, and paying the amount caused by the transaction to the exporter when the exporter requests pre-deposit, the pre-deposit processor deducting a commission from the amount according to a commission rate variable with respect to the importer's credit information, and paying the remainder to the exporter.

3. In a trade transaction system for processing a settlement caused by a transaction of an importer and an exporter, a trade settlement system using a credit card, comprising:
an importer transaction server including: a card holder database for storing credit card information and credit information of the importer; a transaction database for storing a transaction history between the importer and the exporter; an approval processor for processing transaction approval on the basis of credit information of the importer when the importer requests transaction approval; and a settlement processor for receiving a transaction amount from the importer on a settlement day concluded according to approval of the transaction (where the settlement data is variable by the importer), and settling the amount provided to the exporter; and
an exporter transaction server including: a merchant database for storing merchant information of the exporter; a transaction database for storing a credit card approval history caused by a transaction between the importer and the exporter; a transaction processor for receiving a transaction approval history from the importer, notifying the exporter of the transaction approval history, and providing a transaction amount to the exporter according to an instruction of the importer transaction server; and a pre-deposit processor for checking the transaction approval history, deducting a commission from the amount according to a commission rate variable by the importer's credit information, and paying the remainder to the exporter when the exporter requires pre-deposit.

4. The system of claim 3, wherein the importer transaction server further comprises:
a purchase database for storing a purchase request history provided by the exporter transaction server; and
a purchase processor for comparing a payment request history provided by the importer with the purchase request history, and processing the purchase when they are matched wherein the purchase processor provides a purchase processing result to the exporter transaction server to be notified to the exporter.

5. The system of claim 3, wherein the importer transaction server provides an approval cancellation history provided by the importer to the exporter transaction server to be notified to the exporter, and cancels the approval when an approval cancellation checking history provided by the exporter transaction server and an approval cancellation history of the importer are matched, and the exporter transaction server provides the importer transaction server with an approval cancellation checking history provided by the exporter that has checked the goods that are returned from the importer.

6. A trade settlement method of a system including an importer transaction server and an exporter transaction server connected to each other through a network, the system processing the settlement caused by a transaction of an importer and an exporter, comprising:
the importer transaction server checking a line of credit and a credit rank on the basis of a credit card number, and issuing approval, when the importer provides the credit card number, a transaction history including a settlement day established by the importer, and an approval request;
the importer transaction server providing an approval history to the exporter transaction server to be notified to the exporter;
the exporter transaction server providing a transaction amount to the exporter;
the importer transaction server notifying the importer to deposit the amount on the settlement day; and
the importer transaction server settling the amount provided by the exporter transaction server to the exporter by using the amount deposited on the settlement day.

7. The method of claim 6, further comprising:
the exporter transaction server providing a purchase request history to the importer transaction server when the exporter requests a purchase;
the importer transaction server comparing the purchase request history of the exporter with a payment request history provided by the importer when a payment request is provided from the importer that has received goods;
processing the purchase when the purchase request history and the payment request history are matched; and
notifying the exporter and the importer of a purchase processing result through the exporter transaction server.

8. The method of claim 6, further comprising:
the exporter transaction server requesting an approval history or a purchase history checking from the importer transaction server when the exporter requests pre-deposit before a payment day;
the importer transaction server providing the exporter transaction server with the approval history or a purchase history checking result together with information on a merchant commission rate calculated according to the credit rank of the importer; and
the exporter transaction server deducting a commission from the amount and providing the remainder to the exporter.

9. The method of claim 6, further comprising:
the importer transaction server providing an approval cancellation request to the exporter transaction server to be notified to the exporter, when the importer generates the approval cancellation request;
the exporter providing the importer transaction server with an approval cancellation checking history provided by the exporter that has received the returned goods from the importer; and
the importer transaction server comparing the approval cancellation history provided by the importer with the approval cancellation checking history provided by the exporter, and canceling the transaction approval using a credit card between the importer and the exporter when the histories are matched.

10. The method of claim 9, further comprising:
the exporter transaction server providing an objection history to the importer transaction server when the exporter is notified of the approval cancellation request and requests the objection;
the importer transaction server notifying the importer of the objection history;
the importer transaction server notifying a judgment system of an objection-raised transaction history;
the importer transaction server respectively notifying the importer and the exporter of a judgment result when the judgment system notifies of the judgment result on the objection; and
the importer transaction server canceling the approval or paying the amount according to the judgment result.
